(19) United States
(12) Patent Application Publication
(10) Pub. No.: US 2005/0139533 A1
(43) Pub. Date: Jun. 30, 2005

(54) Electrophoretic separation system

(76) Inventors: Kevin Andrew Auton, Cambridgeshire (GB); Sergei Mikhailovich Schurov, Cambridgeshire (GB); Paul Thomas Ryan, Cambridgeshire (GB)

Correspondence Address: NIXON & VANDERHYE, PC, 1100 N GLEBE ROAD, 8TH FLOOR, ARLINGTON, VA, 22201-4714, US

(21) Appl. No.: 10/504,963

(22) PCT Filed: Feb. 12, 2003
(86) PCT No.: PCT/GB03/00620

(30) Foreign Application Priority Data
Feb. 19, 2002 (GB) 0203855.2
Apr. 16, 2002 (GB) 0208618.9

(51) Int. Cl. B01D 61/42

(52) U.S. Cl. 210/149; 210/184; 210/321.84; 204/450; 210/243

(57) ABSTRACT

An electrophoresis device for use in separating a mixture of analytes in a fluid sample is provided, the device comprising a first dimension separation medium through which the analytes may migrate, the separation medium being carried on one face of a flexible sheet, the surface area of that face being greater than that of the region of contact between the separation medium and the sheet, wherein the first dimension separation medium is located within a first separation zone which is defined at least partly by the flexible sheet, the device further comprising a fluid chamber, separated from the first dimension separation zone by the flexible sheet, in which fluid may be retained in contact with that face of the sheet opposite to the face on which the separation medium is carried. The device may additionally comprise a second separation zone, in which a second separation medium may be located, in order to carry out a second dimension electrophoretic separation.

### FIELD OF THE INVENTION

This invention relates to analyte separation systems and their use, in particular to gel electrophoresis systems.

### BACKGROUND TO THE INVENTION

Gel electrophoresis is a known technique for separating a mixture of analytes. An electric field is applied across a gel through which the mixture, in the form of a fluid sample, can migrate. The speed of migration of each analyte, under the influence of the electric field, may depend on a variety of analyte properties such as molecular weight or isoelectric point. As a result, the analytes separate along the gel in the direction of the applied field.

In the case of protein analytes, such a separation may typically be done by isoelectric focussing, in which a pH gradient causes separation of the proteins according to their isoelectric points (the pHs at which the proteins have no net charge). According to the “immobilised pH gradient” (“IPG”) technique, the pH gradient may be incorporated in a gel, for instance in the form of a strip bound to an inert substrate, to which the protein mixture is applied.

Such “IPG strips” are well known and a variety of techniques is available for their preparation, including those described for instance in U.S. Pat. No. 5,993,627, U.S. Pat. No. 4,130,470, U.S. Pat. No. 5,534,121 and EP-0 393 478. An IPG strip may be carried on a film backing such as of Gelbond™ (as in U.S. Pat. No. 5,993,627), in which case the backing layer tends to have dimensions similar to, and little greater than, those of the strip itself. In use in a separation system the strip and backing layer are located on a separate support such as a plate or block.

IPG strips are typically available in a pre-prepared and dried form, which is then re-hydrated with the sample fluid prior to use so that the sample is drawn into the gel. Processing of the strips can involve the application of a number of sample and/or reagent fluids, including for example buffers and wash fluids.

During use of an IPG strip to conduct an electrophoretic separation, it needs to be protected from environmental contaminants and from dehydration. This is typically achieved by immersing the strip in silicone oil during the separation process, or at least covering it with a protective layer of impermeable plastic film. Such protectants can cause handling difficulties.

An IPG strip also needs to be cooled during the separation process, to compensate for temperature increases caused by the applied electric field. This too can often present processing difficulties. Typically, cooling needs to be carried out by fitting the strip into a block made of a thermally-conductive material then cooling one or more faces of the block by conventional means. However since the electrophoretic separation requires the application of a high electric field, it is essential that the materials in contact with the strip are not electrically conducting, and this limits the achievable thermal conductivity of the supporting block.

Resolution of an electrophoretic separation can be improved by conducting two successive separations. Initially the analytes are separated according to a first property, and the thus-separated mixture is then applied to another gel and subjected to an electric field to separate its components according to a second, different, property. This technique, known as two-dimensional gel electrophoresis, was first reported in 1975 (O'Farrell, P H [1975] J. Biol. Chem. 250: 4007-4021). It is commonly used to separate mixtures of biological analytes such as proteins.

The “first dimension” separation may be carried out using an IPG strip as described above. The “second dimension” separation is then typically performed by the common technique of slab gel electrophoresis, in which analyte (for instance, protein) mobility through the applied electric field depends on molecular weight and degree of charge. The first dimension separation must proceed to completion before the thus-separated analytes are allowed to migrate into, and through, the second dimension gel, typically by bringing the gel on which the first dimension separation was carried out into contact with the second gel. Again, a number of ways of achieving the first to second dimension transfer is known, for instance as described in U.S. Pat. No. 5,993,627, U.S. Pat. No. 6,013,165, EP-0 366 897 and EP-0 877 245 and in our co-pending PCT patent application no. PCT/GB02101749.

### STATEMENTS OF THE INVENTION

According to a first aspect of the present invention, there is provided an electrophoresis device for use in separating a mixture of analytes in a fluid sample, the device comprising
a first dimension separation medium through which the analytes may migrate, the separation medium being carried on one face of a flexible sheet, the surface area of that face being greater than that of the region of contact between the separation medium and the sheet, wherein the first dimension separation medium is located within a first separation zone which is defined at least partly by the flexible sheet,
the device ether comprising a fluid chamber, separated from the first dimension separation zone by the flexible sheet, in which the fluid may be retained in contact with that face of the sheet opposite to the face on which the separation medium is carried.

The separation medium is suitably an aqueous gel, of the type conventionally used for gel electrophoresis, such as polyacrylamide. It is preferably capable of isoelectric focussing of analytes when an electric field is applied across it. It may for instance take the form of an immobilised pH gradient (IPG) element, which incorporates a pH gradient along one of its dimensions.

The separation medium is preferably in the form of an elongate element such as a strip or cylinder. Typical dimensions for a gel strip of this type are a thickness of between 0.1 and 1.5 mm, preferably between 0.4 and 0.8 mm; a length (this being the direction of analyte movement in use) of between 50 and 500 mm, preferably between 100 and 350 mm, more preferably between 150 and 320 mm, most preferably about 300 mm; and a width of between 2 and 5 mm, preferably 3.5 mm.

The separation medium should be supported on, and preferably permanently secured to, the flexible sheet. It may be applied to the sheet either by being formed in place or by a separate adhesion process after manufacture of the medium. One method of forming in place is to use a moving nozzle to dispense a mix of gel ingredients onto the sheet. As the nozzle moves along the desired track of the separation medium, the mix of ingredients is altered to give the necessary gradient of immobilized pH. Another method for forming in place is to apply or dispense a base gel (eg, polyacrylamide) then to spray immobilisable ampholytes into the gel to create the necessary gradient. The separation medium may be in a dehydrated form prior to use in a separation process.

Preferably, the sheet is made from a material which, or carries a coating which, promotes adhesion of the separation medium to the sheet. For example, the sheet may be of the proprietary type Gelbond™ which carries a coating to which a polyacrylamide gel may covalently bond.

The sheet is ideally sufficiently flexible to be capable of the cooling and sealing functions described below. It should be made from an inert and fluid impermeable material, suitably a synthetic plastics material such as polyester. Preferred sheet thicknesses are in the range 20 to 500 μm, more preferably between 25 and 200 μm, most preferably between 50 and 150 μm.

The area of the relevant sheet face is preferably at least 15 times, more preferably between 20 and 200 times, most preferably between 30 and 100 times, that of the region of contact between the separation medium and the sheet. It is ideally sufficiently large that it may also serve as a backing for a second dimension separation medium, as described below. Suitable dimensions for the sheet are between 100 by 40 mm and 400 by 600 mm.

Supporting a first dimension separation medium, such as an IPG strip, on a larger flexible sheet can offer a number of advantages. It can facilitate handling of the separation medium and its location within an electrophoresis device. In addition, the sheet can be used as part of a cooling system during an electrophoretic separation carried out across the separation medium as described below.

The flexibility of the sheet, which gives the ability to deform or displace it locally by the application of preferably relatively low pressures, may be used as described below to assist in reversibly isolating one or more fluid-containing regions of the electrophoresis device, particularly around the first dimension separation medium.

The flexible sheet serves at least partly to define a first separation zone within the device of the invention, which first separation zone contains the first dimension separation medium. The sheet is preferably unsupported by any base plate or analogous support means in the region of this first separation zone.

This can conveniently be achieved if the device of the invention comprises means for applying pressure to one or more regions of the sheet proximal to the first dimension separation medium, so as to deform and/or displace the sheet in that region or regions. The deformation and/or displacement may then cause the sheet to contact a sealing element within the device so that the sealing element and sheet together at least partly define an enclosed fluid-tight first separation chamber containing and/or in contact with at least part of the first dimension separation medium. The deformation and/or displacement of the sheet is preferably reversible, to allow the separation chamber to be closed or opened as and when desired.

The term “fluid-tight” in this context encompasses a chamber having one or more fluid inlet or outlet conduits, via which fluids may be introduced to or evacuated from the chamber when desired.

The sealing element with which the sheet comes into contact may be for example a gasket, or any other region of the device against which a fluid-tight contact may be made by applying pressure to urge the sheet into contact with that region.

The thus-defined first separation chamber is preferably of relatively low volume, for instance between 200 μl and 2 μl or between 1 times and 4 times the volume of the separation medium after hydration. It is particularly suitable to carry out a first dimension separation within such an enclosed, low volume chamber, since the first dimension separation medium may be contacted with, and ideally immersed in, the necessary fluids (eg, sample fluids, reagent fluids, wash fluids, buffers and the like, also possibly imaging reagents such as staining agents) during the separation process. The separation medium is thus protected, without the need -for oil layers or other forms of protective barrier.

The first separation chamber should however be of a size suitable to allow at least a degree of fluid movement around the enclosed first dimension separation medium, to allow fluids to be absorbed by the separation medium.

Instead or in addition, deformation and/or displacement of the sheet may be used to bring the first dimension separation medium itself into contact with a sealing element within the device, the separation medium and the sealing element together at least partly defining a first separation chamber of the type described above.

The fluid chamber may function as a control chamber to which control chamber a pressurised control fluid may be supplied. The control chamber is preferably at least partly defined by the sheet. The desired deformation/displacement of the sheet may be achieved by applying either a positive or a negative differential pressure to the control chamber, depending on the geometry of the device, thereby altering the pressure of the control fluid. Such pressure is applied to the face of the sheet opposite to that carrying the separation medium.

The flexible sheet may additionally function as part of a temperature control system in the device of the invention. The device preferably comprises means for transferring heat to and from, typically from, one or more regions of the sheet. This preferably comprises means for supplying a temperature regulating fluid to one or more regions of the sheet, preferably to the surface opposite to that which carries the first dimension separation medium and preferably to a region of that surface which is proximal to, more preferably directly behind, the separation medium. Because the sheet is relatively thin, and has a larger area than that of the separation medium, it can act as an efficient medium for heat transfer, in particular as an interface between the separation medium and a large volume of temperature regulating fluid, hence greatly facilitating the transfer of heat to and from the separation medium and any fluids in contact with it.

Typically the temperature regulating fluid will be used to cool the separation medium and surrounding fluids during application of an electric field during a separation process. A suitable cooling fluid is water.

The device preferably comprises a temperature regulating chamber positioned adjacent to, and preferably in fluid contact with, the appropriate region(s) of the flexible sheet, to which chamber the temperature regulating fluid may be supplied.

The temperature regulating chamber is thus preferably at least partly defined by the flexible sheet. The area of contact between the temperature regulating fluid and the sheet should be as large as possible and should include the region immediately surrounding the first dimension separation medium. Thus, ideally, the chamber is in contact with an area of the sheet between one and two hundred times that of the area of contact between the separation medium and the sheet. The temperature regulating chamber is conveniently of a relatively small depth, for instance between 0.2 and 10 mm, and the temperature regulating fluid preferably flows through this narrow chamber over a large area of the flexible sheet.

The fluid chamber may suitably function as the temperature regulating chamber. Preferably, the fluid chamber functions as both a control chamber and a temperature regulating chamber, in which case the temperature regulating fluid may also be used as the control fluid, when supplied at an appropriate pressure.

The device of the present invention may be used to carry out a single one dimensional electrophoretic separation, in which case it need only contain the first dimension separation medium and associated means for instance for applying an electric field across it, for supplying fluid(s) to it and for regulating its temperature during the separation process.

However, locating the first dimension separation medium on a flexible sheet in a device according to the invention may also facilitate two dimensional separation. The sheet may serve at least partly to define a second separation zone within the device, in which second separation zone a second separation medium (typically an aqueous gel such as a polyacrylamide gel) may be located in order to carry out a second dimension electrophoretic separation. The second separation zone may be separate from or separable from (eg, using a removable barrier such as is described in our co-pending PCT patent application no. PCT/GB02/01749, more preferably by means of localised deformation/displacement of the sheet itself as described above) the first separation zone containing the first dimension separation medium.

More preferably still, the first and second separation zones can be reversibly isolated from one another, for instance via localised deformation/displacement of the sheet. A first dimension separation may then be carried out whilst the first dimension separation medium is enclosed in a first separation chamber (ie, with pressure applied to the flexible sheet in the region of the first dimension separation medium, as described above), following which the first chamber can be brought into fluid contact with the second zone (removal of sheet pressure) to allow migration of analytes from the first separation medium to a second separation medium contained in the second separation zone.

In such a device, the fluid chamber preferably allows fluid to be retained in contact with the flexible sheet in regions corresponding to both the first and second separation media.

In use, the second separation medium need only be introduced into the second separation zone when the first dimension separation is complete. It may be introduced for instance in the form of an aqueous liquid which can subsequently be allowed to set into a slab gel, for example by in situ polymerisation within the device. Typically the second separation medium takes the form of a slab gel between 0.5 and 2 mm thick, preferably between 0.8 and 1.8 mm, more preferably about 1.5 mm thick—these are also, therefore, the preferred depths for the second separation zone.

The second separation medium may be introduced so as to contact, or even to surround, the first dimension separation medium. More conveniently, however, it is introduced in such a way as to leave a cavity between the first and second separation media, which cavity may be filled with an appropriate medium such as an agarose gel to allow analytes to move onto the second separation medium at the desired time. In both cases, the second separation zone may effectively incorporate, or at least be in fluid communication with, the first.

Where such an intermediate cavity is allowed between the first and second separation media, it is clearly desirable that the analyte separations achieved in the first separation zone should be preserved whilst the analytes travel on to the second zone. To this end, the design of the cavity and the conditions under which it is used should be selected to minimise distortion of the analyte separations achieved in the first zone, which means minimising analyte movement in particular in the direction along which the first zone separation was effected.

The amount of analyte “drifting” which can be tolerated depends to an extent on the resolution achievable in the separation media used; analyte movement in the relevant dimension, as the analytes traverse the cavity, should ideally be over distances smaller than the-best achievable resolution. A typical currently available gel provides a useful resolution of down to about 0.5 mm; analyte movement is suitably less than 0.5 mm, ideally less than 0.3 mm, when using such gels.

The degree of analyte movement within the intermediate cavity can depend on a number of factors, such as the viscosity of the medium or media present in the cavity, the length of the cavity (in the direction of sample movement), the applied electric field, the applied pressure gradient and the nature, and therefore mobility, of the analytes themselves. These factors, in particular the pressure gradient, can in turn be affected by external influences such as temperature, gravity, device movement and even fluid movement in connecting apparatus.

A suitable medium for use in the intermediate cavity is a relatively viscous fluid such as molten agarose (at a temperature of for instance, between 50 and 70° C.). Suitable fluid viscosities may be between 2 and 1000 mPa.s (measured at room temperature and pressure), preferably between 5 and 500 mPa.s, more preferably between 5 and 20 mPa.s, such as about 10 mPas. Buffer fluids, such as are commonly used in gel electrophoresis separations, may also be present.

Generally speaking, analyte movement can be reduced by reducing the degree of fluid movement possible within the intermediate cavity. This in turn can be controlled by for example:
i) filling the cavity with a more viscous fluid, such as by incorporating a gelling agent such as polyacrylamide or agarose;
ii) reducing, preferably minimising, the length of the cavity (in the direction of analyte movement through it)—a suitable length might be, for example, between 0.5 and 5 mm, preferably between 1 and 3 mm, more preferably about 2 mm;
iii) including fluid flow control valves in the vicinity of the cavity, so as to effect control over fluid movement which might arise for example due to external influences; and/or
iv) mounting the device in a rigid support, again so as to minimise fluid movement during use.

To facilitate introduction of the second separation medium and if applicable a medium for the intermediate cavity, one or more fluid level sensors may be incorporated into the device of the invention. A convenient form is an optical level sensor, for instance one which introduces light into the relevant zone through an appropriately shaped light guide and detects the light reflected back from an internal surface of the guide, the extent and nature of the reflection being dependent on the fluid present in the zone in the region into which the guide extends.

The fluid chamber may function as a control chamber to operate to reversibly isolate the second separation zone in the same manner as described above for the first separation zone.

The temperature within the second separation zone may also suitably be controlled in the same manner as described above in connection with the first dimension separation, ie, by contacting at least a region of the flexible sheet, within the second separation zone, with a temperature regulating fluid. The temperature regulating chamber of the device may be common to both the first and second separation zones, ideally by being in fluid contact with a substantial proportion (eg, 90% or greater) of the area of the relevant sheet face.

In the device of the invention, the flexible sheet is thus preferably of sufficiently large surface area as to provide a backing for a second dimension separation medium such as a slab gel, which also then provides a large surface area across which the second dimension separation medium may be cooled.

The first and second separation zones, and ideally also their associated temperature regulating and/or control chambers, may conveniently be provided between two plates. The plates may be made of glass or a similar material such as perspex or polycarbonate, sealed at their edges.

In a typical device according to the invention, the second separation medium is 50 to 500 mm, preferably between 100 and 350 mm, more preferably between 150 and 320 mm, most preferably about 300 mm long in the direction of analyte movement in use. The second separation zone is typically 50 to 600 mm preferably between 50 and 400 mm, more preferably between 60 and 350 mm, most preferably about 300 mm long in the direction of analyte flow.

Other features of a separation device according to the invention, for instance arrangements for the supply of fluids to the separation zone(s) and for the application of electric field(s) across them, may be as in known one or two dimensional gel electrophoresis devices.

The device may be at least partially automatically operable, for instance under the control of programmable control means such as a microprocessor. Such control means may be used in particular to control deformation/displacement of the flexible sheet at appropriate times to allow or prevent fluid communication with the first dimension separation zone.

A device according to the invention may be used to separate a mixture of analytes such as proteins, peptides, charged polysaccharides, synthetic polymers or any other chemical or biological analytes which are capable of electrophoretic separation, in particular proteins. The sample containing the mixture should be in the form of a fluid, more preferably a liquid such as an aqueous solution or suspension. Sample preparation, prior to use of the device, may be conventional.

An alternative aspect of the present invention provides apparatus with which to carry out one or preferably a plurality of electrophoretic separations, the assembly comprising at least one, preferably two or more, more preferably four or six or eight or sixteen or more electrophoresis devices in accordance with the first aspect of the invention.

Apparatus in accordance with the invention can allow the simultaneous execution of a plurality of one or two dimensional electrophoretic separations. It lends itself particularly well to automation, since the operation of each of its constituent devices may be automated. The apparatus preferably comprises control means such as a microprocessor for operating the devices, preferably individually, and for regulating the supply of fluids, electrical power and the like to them.

The present invention will now be described by way of example only and with reference to the accompanying illustrative drawings.

### BRIEF DESCRIPTION OF THE DRAWINGS

FIG. 1 is a longitudinal section through an electrophoresis device according to the invention;

FIGS. 2A, 2B and 2C are more detailed sections through parts of the FIG. 1 device, showing different stages in its operation;

FIG. 3 is a section through part of a device according to the invention, showing an alternative electrode arrangement;

FIG. 4 is a section through part of another device according to the invention, showing an alternative electrode arrangement;

FIG. 5 is a section through part of an alternative electrophoresis device according to the invention;

FIG. 6 is a part section along the line VI-VI in FIG. 5; and

FIG. 7 is a section through part of another device according to the invention.

All figures are schematic.

### DETAILED DESCRIPTION

The following relates to electrophoretic separations in which the first dimension separation is effected by means of an IPG strip and the second (if applicable) on a slab gel, with the application of orthogonal electric fields across the first and second separation zones. Other electrophoretic separation techniques may be practised using the present invention.

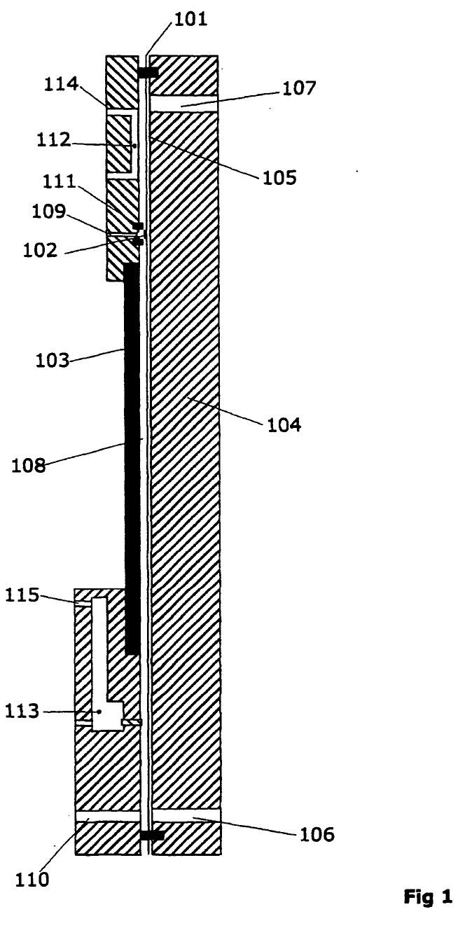

The electrophoresis device shown in FIG. 1 may be used to conduct either a single dimension or, more preferably, a two dimensional separation.

The device comprises a 80 μm thick flexible polyester sheet 101 on which a gel IPG strip 102 has been formed. This is secured in place between front and back support plates labelled 103, 104 respectively. Between the sheet 101 and the back plate 104 a narrow rear chamber 105 allows for the supply of cooling fluid to the rear face of the sheet, the fluid (eg, water) being introduced through inlet 106 and evacuated through outlet 107.

The other face of the sheet 101 serves partly to define a front chamber 108, which fluids may be introduced into or evacuated from via the conduits 109, 110. In the region of the IPG strip 102, a sealing gasket 111 is provided on the front plate 103.

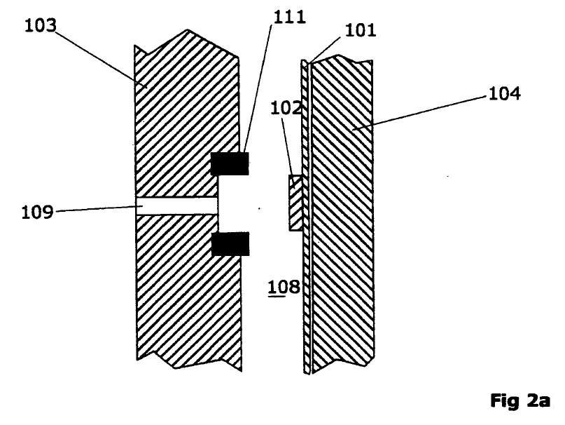

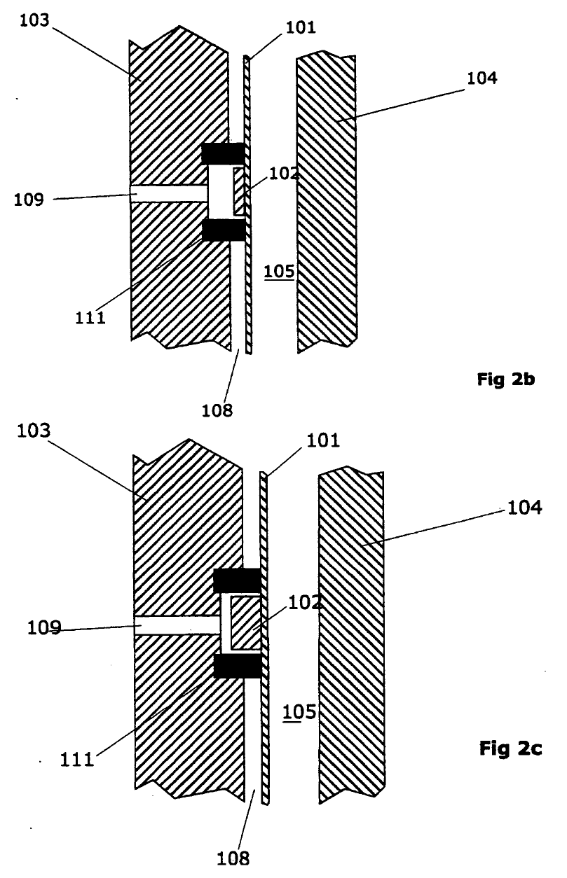

When the pressure in the rear chamber 105 is relatively low, as shown in FIG. 2A, the IPG strip is not in contact with the gasket 111. By applying a positive fluid pressure in the rear chamber 105, the sheet 101 can be urged into contact with the gasket 111, thus defining a low volume enclosed chamber around the IPG strip (see FIG. 2B). Sample and/or reagent fluids (including, for instance, imaging agents such as stains) may be introduced into this chamber via the conduit 109, causing the dehydrated IPG strip to swell (FIG. 2C). An electrophoretic separation may be carried out on the IPG strip in a protected and controlled micro-environment. Efficient cooling of the strip, during the separation, is easily achieved via the rear chamber 105.

To perform a first dimension separation it is necessary to apply an electric field along the length of the IPG strip. This is conventionally done using electrodes at either end and applying a high voltage between them. In the FIG. 1 device, items 112, 113 are such electrode wires and extend across the device parallel to the longitudinal axis of the IPG strip. Conduits 114, 115 allow the supply of buffer liquids to the two electrodes, in conventional fashion but preferably being continuously replenished from reservoirs (not shown).

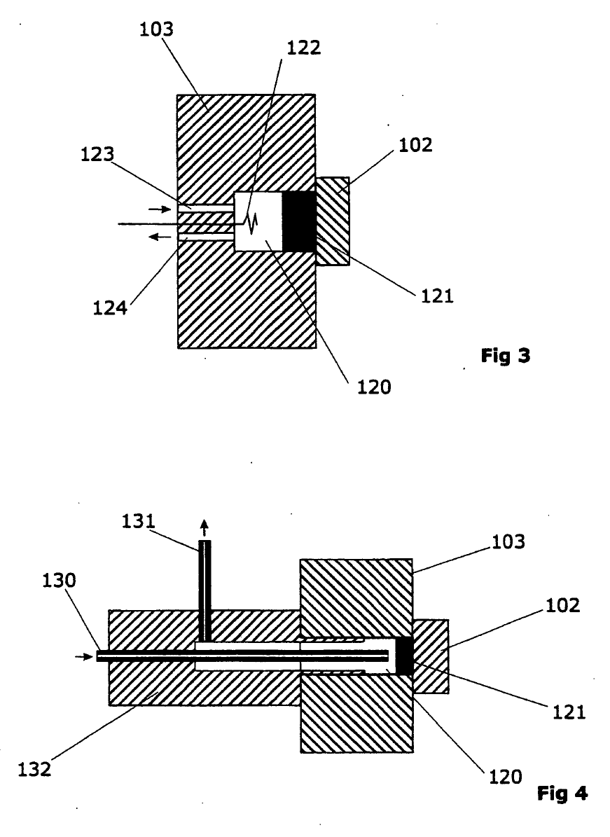

To avoid contamination with metal ions, platinum wire is normally used for the electrodes. When the voltage is applied, some constituents of the hydrated strip arrive at the electrodes. To avoid them interfering with the remainder of the strip it is known to include a damp absorbant wick (usually paper) between the electrode and the strip. One method of achieving the same function is shown in FIG. 3, in which parts analogous to those shown in FIGS. 1 and 2 have been given the same reference numerals.

At positions corresponding to the two ends of the IPG strip 102, cylindrical cavities 120 (typical cross sectional diameter 2.5 mm) are provided in plate 103. In each of these cavities is incorporated a porous plug 121, preferably made of paper. Below the plug is an electrode wire 122, for example platinum, and two ports 123, 124 for entry and exit of electrode buffer liquid. Preferably, the liquid is drawn by vacuum from a reservoir by a pump. This helps prevent flooding of the strip by excess buffer liquid.

The liquid fills the remainder of the cavity 120 and soaks into the EPG strip. In doing so, it makes an electrical path from the electrode 122 to the porous plug 121 and so to the IPG gel that is in contact with the plug. The buffer liquid not only provides the electrical contact but also helps maintain pH at the end of the strip. The electrode at the acid end of the strip could use phosphoric acid of 0.001 to 0.5 M, preferably 0.005 to 0.02 M. The electrode at the basic end could use sodium hydroxide of a similar molarity.

Preferably the buffer liquids are made to flow slowly as electrophoresis progresses. This flow helps to remove bubbles of gas generated at the electrodes and flushes away species that have migrated to the electrodes. Preferably, the buffer flow rate is 0.1 to 10 ml/min.

An alternative form of electrode arrangement is shown in FIG. 4. Again, parts analogous to those in FIGS. 1, 2 and 3 have been labelled with the same reference numerals.

In the FIG. 4 arrangement, the electrode wire is integrated with one or more small metal tubes. One tube 130 acts as inlet for buffer liquid and directs its flow at the porous plug 121, the second (131) drains excess liquid from the cavity 120. The arrows indicate the directions of fluid flow in use. Either or both of the tubes may be metal and act as an electrode. Likewise the body 132 joining the tubes may also be metal.

If a second dimension separation is to be carried out subsequent to the first, the pressure in rear chamber 105 can be reduced, drawing the sheet 101 away from gasket 111 (see FIG. 2A). The IPG strip is then no longer isolated from the rest of the front chamber 108. Reagents to make a polyacrylamide gel can be introduced in liquid form into the front chamber, via the lower inlet conduit 110, to an appropriate level. This level may be such as to contact or even immerse the IPG strip. However, it is preferred that the second dimension gel be spaced from the IPG strip by a small amount, leaving an inter-zone cavity which may subsequently be filled with for example molten agarose when analyte migration to the second separation zone is desired. The agarose may be introduced through an inlet provided in the chamber 108, conveniently just below the IPG strip 102, to a level which contacts or more preferably immerses the IPG strip.

To facilitate introduction of the second separation medium and if applicable a medium for the inter-zone cavity, one or more fluid level sensors may be incorporated into the device. A convenient form is an optical level sensor, for instance one which introduces light into the relevant fluid chamber through an appropriately shaped light guide and detects the light reflected back from an internal surface of the guide, the extent and nature of the reflection being dependent on the fluid present in the chamber in the region into which the guide extends.

Once the second dimension liquid gel has set, and if applicable a medium such as agarose has been introduced into the inter-zone cavity and allowed to solidify, the second dimension separation can be carried out, the analytes separated on the IPG strip being free to migrate into the second dimension gel under the influence of an applied electric field.

Again during the second dimension separation, the gel temperature can be controlled by passing a cooling fluid through the rear chamber 105.

Uniform electrophoretic separation in the second dimension requires that the thickness of the gel is uniform across the area of the slab formed in chamber 108. If the sheet 101 is not rigidly supported then the chamber 108 may vary in thickness. One way to support the sheet is to apply a negative differential pressure (relative to front chamber 108) until the sheet is pulled firmly against the face of rear plate 104. The latter may be made accurately flat, however this will reduce the opportunity for cooling fluid to flow over the area of the sheet. Thus it may be preferable to provide narrow grooves in the inner face of plate 104, and allow the cooling liquid to flow through them. The grooves are made at a spacing sufficiently small that there is adequate thermal coupling between areas of sheet 101 between the grooves and the cooling liquid.

Preferably, the plate 104 is made from a thermally conductive material, such as aluminium. This improves the flow of heat from the sheet to the cooling liquid. The conductivity of the plate 104 may be sufficiently high that liquid cooling is not required; heat may be lost through the thickness of the plate to -the environment on the opposite face, aided by fins or other heat exchange devices on that face. It is important that grooves in the plate 104 are narrow so that the sheet does not deform substantially where it is unsupported. Typically, grooves may be between 0.5 and 3 mm in width.

The sheet 101 and IPG strip 102 are typically disposable items, supplied either separately to or in combination with the rest of the device. Preferably the sheet and strip are supplied as a single item which may be fitted into a reusable processing cassette comprising the remaining parts as described above.

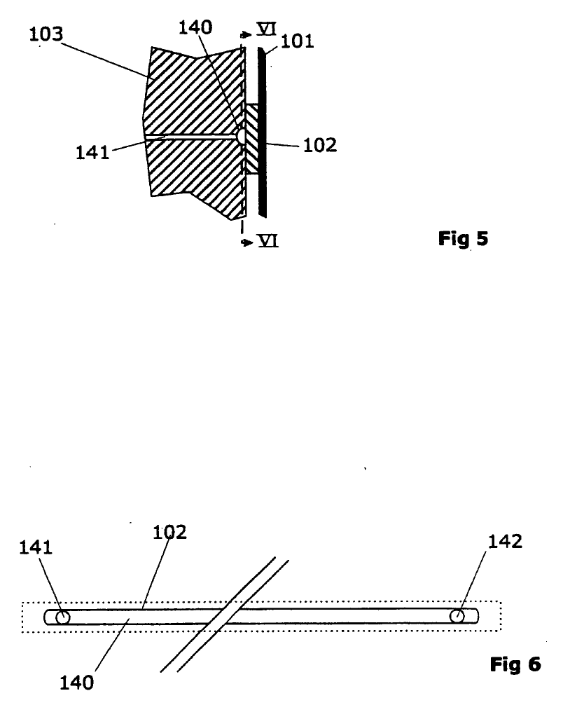

Note that the IPG strip need not necessarily be enclosed (by the sheet 101 and gasket 111) during the first dimension separation. It may be soaked in sample-containing liquid prior to being placed in the system for electrophoretic separation. Alternatively, rehydration of the strip by sample liquid may be done in the device but without the use of a defining seal 111. Part of a device suitable for use in this way is shown in FIGS. 5 and 6.

In this arrangement, when control pressure is applied to the sheet 101, the IPG strip 102 contacts the inner face of the front block 103. Within the contact area a groove 140 is provided in the face of the plate 103. Fluids may be passed to and from this groove via one or more ports such as 141, 142. In this way, sample liquid or reagents may be brought into contact with at least part of the face of strip 102 into which they soak. Since the strip is typically permeable, the liquid may migrate to all parts of the strip. Provided that any gaps between the face of the strip and the plate 103 are small (eg, less than 0.3 mm) then the liquids may be held in contact with the strip by the action of surface tension for periods of hours without loss.

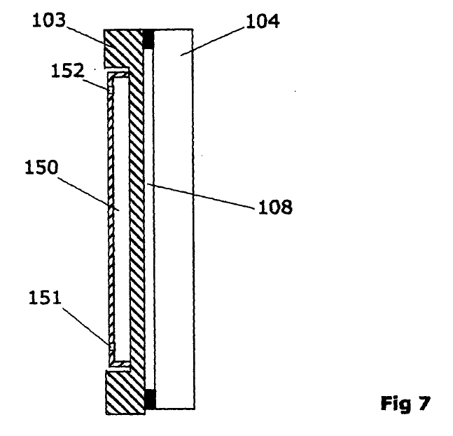

In devices such as those described above, the plate 103 is preferably transparent so that the electrophoresis progress and final separation may be observed without the need to dismantle the device. However, a problem can occur where heat generated in the gel leads to a temperature difference between its faces; this in turn leads to differential rates of electrophoretic separation showing as streaking of species in the final separation pattern. Preferably, cooling of the second dimension get is symmetrical to reduce this effect. If the plate 103 has to remain transparent, then a jacket of cooling water may be added, as in the device shown in FIG. 7, in which a temperature regulating chamber 150 is provided adjacent the front plate 103. Cooling liquid may be introduced through inlet 151 and evacuated through outlet 152.

Alternatively, if viewing of the gel is not essential, then the front plate 103 may be of grooved aluminium or similar, as described above in connection with cooling of the rear plate 104. A further variant is where this latter method is used, but a small transparent window is included in the cooling plate, allowing viewing over a narrow strip. This may be particularly effective when the migration of species is to be detected optically (eg, by fluorescence of attached dyes) along a strip orthogonal to the migration direction and recorded as separation progresses. From such a recording it would be possible to mathematically synthesise a composite area image of how the species would appear after a period of separation. This may be further improved by imaging through more than one strip and recordings from the strips can be correlated on a time-dependent basis.

1. An electrophoresis device for use in separating a mixture of analytes in a fluid sample, the device comprising a first dimension separation medium through which the analytes may migrate, the separation medium being carried on one face of a flexible sheet, the surface area of that face being greater than that of the region of contact between the separation medium and the sheet,
wherein the first dimension separation medium is located within a first separation zone which is defined at least partly by the flexible sheet,
the device further comprising a fluid chamber, separated from the first dimension separation zone by the flexible sheet, in which fluid may be retained in contact with that face of the sheet opposite to the face on which the separation medium is carried.

2. A device according to claim 1, with means for reversibly isolating the first separation zone to form a fluid region.

3. A device according to claim 2, wherein the means for reversibly isolating the first separation zone comprises a sealing element which together with the flexible sheet at least partly defines the first separation zone when a region of the sheet is deformed to cause it to contact the sealing element.

4. A device according to claim 1, wherein the fluid chamber is a control chamber containing a control fluid, the arrangement being such that deformation of the flexible sheet may be caused by altering the pressure of the control fluid in the control chamber.

5. A device according to claim 1, comprising means for transferring heat to and/or from one or more regions of the sheet.

6. A device according to claim 5, wherein the fluid chamber contains a temperature regulating fluid which functions to transfer heat to and/or from the flexible sheet.

7. A device according to claim 4, wherein the fluid chamber is both a control chamber and a temperature regulating chamber.

8. A device according to claim 1, wherein the first separation medium comprises an immobilised pH gradient (IPG) element.

9. A device according to claim 1, wherein the surface area of that face of the flexible sheet which carries the first separation medium is at least 15 times that of the region of contact between the separation medium and the sheet.

10. A device according to claim 1, additionally comprising a second separation medium located within a second separation zone, which second separation zone is defined at least partly by the flexible sheet.

11. A device according to claim 10, wherein the fluid chamber allows fluid to be retained in contact with the flexible sheet in regions corresponding to both the first and the second separation media.

12. A device according to claim 11, wherein the fluid chamber contains a temperature regulating fluid which functions to transfer heat to and/or from both the first and the second separation zones via the flexible sheet.

13. A device according to claim 10, comprising means for applying an electric field across the first and second separation media individually.

14. A device according to claim 1, wherein the device is provided between two plates.

15. (canceled)

16. Apparatus with which to carry out one or more electrophoretic separations, the apparatus comprising at least one electrophoresis device according to claim 1.

17. Apparatus according to claim 16, comprising control means for the automatic operation, individually, of the one or more electrophoresis devices the apparatus comprises.
